(19) United States
(12) Patent Application Publication
(10) Pub. No.: US 2025/0154052 A1
(43) Pub. Date: May 15, 2025

(54) METHOD FOR TREATING THE SURFACE OF AN IONIC AMORPHOUS MATERIAL TO CONTROL THE ORIENTATION OF LIQUID CRYSTALS, METHOD FOR MANUFACTURING MULTI-DOMAIN ALIGNMENT LIQUID CRYSTAL CELLS

(71) Applicants: UNIVERSITE DE BORDEAUX, BORDEAUX (FR); CENTRE NATIONAL DE LA RECHERCHE SCIENTIFIQUE, PARIS (FR); INSTITUT POLYTECHNIQUE DE BORDEAUX, TALENCE (FR); UNIVERSITÉ LAVAL, QUÉBEC (CA)

(72) Inventors: Marc DUSSAUZE, PESSAC (FR); Alice GOILLOT, BORDEAUX (FR); Alexis MAILLARD, BORDEAUX (FR); Vincent RODRIGUEZ, CESTAS (FR); Tigran GALSTIAN, QUÉBEC (CA); Younes MESSADEQ, QUÉBEC (CA)

(21) Appl. No.: 18/838,855

(22) PCT Filed: Feb. 16, 2023
(86) PCT No.: PCT/EP2023/053936

§ 371 Date: Aug. 15, 2024

(30) Foreign Application Priority Data
Feb. 17, 2022 (FR) FR2201425

(51) Int. Cl. C03C 23/00; G02F 1/1337

(52) U.S. Cl. CPC C03C 23/006; C03C 23/007; C03C 23/009; G02F 1/133723

(57) ABSTRACT

A method for treating a surface of an ionic amorphous material for use thereof in the design of liquid crystal cells, the method including arranging the surface of ionic amorphous material in contact with at least one first electrode geometrically structured; applying a temperature to the ionic amorphous material; applying a voltage at the terminals of the first electrode; generating a plasma between two portions of the first electrode from the presence of a gas and the application of a given voltage at the terminals of the first electrode, the application of the voltage at the terminals of the first electrode and the plasma generation being configured to modify the electrical properties of the ionic amorphous material to define a polarized area, and extracting the ionic amorphous material.

### FIELD OF THE INVENTION

The invention relates to a method for electrically treating the surface of an ionic amorphous material, such as glass, for use thereof in the design of a liquid crystal cell so as to control the orientation of said liquid crystals. The field relates to that of liquid crystal cells and structures associated with liquid crystals to control notably their orientation.

### PRIOR ART

Different techniques exist to control the alignment properties of liquid crystals. Generally, a liquid crystal cell is sandwiched between different layers making it possible to maintain the crystals and to control them, notably their alignment. A widely used solution is based on the use of treated surfaces such as those of polymers in order to control the alignments of liquid crystals. These polymer treated surfaces govern, on contact with liquid crystals, the orientation of their alignment. However, it is difficult to obtain multi-domain orientations in the polymer. Indeed, polymer treatment techniques to control the alignments of liquid crystals comprise a surface treatment involving a mechanical operation such as brushing the surface. This technique does not allow regions to be defined in which the electrical or chemical properties of the polymers will be differentiated to orient the liquid crystals along different directions.

Currently, a so-called photo-alignment technique exists making it possible to control locally the alignments of liquid crystals according to delimited regions of the polymer. These techniques impose a photoelectric treatment of the polymer by application of a surface chemistry and a treatment with light of the polymer surface.

Furthermore, conventionally, these polymer treated surfaces may be associated with structured layers including electrodes to form a screen array typically defining pixels/voxels of a display. These electrodes may further be associated with polarizers which can for example be configured to define light filters notably by using the birefringence properties of liquid crystals. The electrodes make it possible to control the dynamic of liquid crystals and their alignment and therefore the properties induced from the light passing through a cell.

These solutions make it possible to control the liquid crystals within a localized space, for example in cells. For this purpose, the use of electrodes allows a local control of the alignments of liquid crystals. These electrodes notably make it possible to apply local electromagnetic fields and to obtain liquid crystal orientation effects for only a part of the cells.

Possibilities also exist for controlling the alignment locally using masks. However, these solutions have the drawback of being hardly configurable.

Conventionally, a glass layer may be used to constitute a transparent support of the liquid crystal cells of a matrix and thereby form an outer protection.

These structures require a high level of manufacturing and implementation complexity. Further, they require numerous components.

Furthermore, the technologies of the prior art had the disadvantage of having low view angles. To increase the viewing angle, it is necessary to vary the alignment microscopically. Techniques have been developed and recently adapted to industrial methods with the aim of remedying this defect. Yet, for the moment, these are based on local depositions of polymers, which is difficult to implement and does not make it possible to obtain a result having an optimal efficiency.

### SUMMARY OF THE INVENTION

According to one aspect, the invention relates to a method for treating a surface of an ionic amorphous material (MA) comprising:
Arrangement of said first surface of the ionic amorphous material in contact with or near at least one first geometrically structured electrode;
Application of a temperature to said ionic amorphous material from a heat source on a first area of said ionic amorphous material;
Application of a voltage at the terminals of the first electrode of a predefined value for a given period;
Generation of a surface plasma at the surface of the ionic amorphous material between at least two portions of the first electrode from the ionization of a gas located between said first surface of ionic amorphous material and different portions of the first electrode and the application of a given voltage at the terminals of the first electrode, said application of the voltage at the terminals of the first electrode and said plasma generation being configured so as to modify the electrical properties of said ionic amorphous material to define at least one locally polarized area between the different portions of the first electrode;
Extraction of the treated ionic amorphous material.

One advantage is to induce a polarization of the glass charges within areas that are able to have dimensions of several hundred micrometers. The distance between two portions of the first electrode may be adapted according to the number of ionic charges contained in the glass.

Another advantage is to define polarized areas according to desired electrical properties according to a given geometry. The definition of polarized areas in the surface of the amorphous material makes it possible for example to control the orientation of liquid crystals sensitive to electric fields.

The proximity between the first surface of ionic amorphous material and the first geometrically structured electrode may correspond to a distance between 0 and 500 microns.

According to one embodiment, the portions of the first electrode are separated by a distance of less than 500 micrometers when these distances are measured in a plane parallel to the plane of the treated surface.

According to one embodiment, the plasma is a cold plasma or a dielectric barrier discharge type plasma. One advantage is to allow the creation of a plasma from a common and easily accessible gas.

According to one embodiment, the first electrode includes an anode arranged in contact with or near a first surface of the ionic amorphous material to be treated and a cathode arranged on or near the second surface of the ionic amorphous material, said gas confined between the first surface of the ionic amorphous material and the different portions of electrodes undergoing an ionization forming plasma discharges.

According to one embodiment, the application of a voltage at the first electrode induces a displacement of the mobile cations under the surface of the ionic amorphous material towards the cathode and a displacement of the negative charge carriers including electrons and/or anions towards the first surface of said ionic amorphous material, said displacement of negative charges at the surface of the ionic amorphous material generating the plasma at the surface of the ionic amorphous material and forming a surface current, the propagation orientation of which is controlled in the plane of said ionic amorphous material by the geometry of the anode.

According to one embodiment, the cathode is homogeneous on contact with the second surface of the ionic amorphous material.

According to one embodiment, the temperature induced by the heat source is between 150° C. and 500° C.

According to one embodiment, the temperature induced by the heat source is between 180° C. and 300° C.

According to one embodiment, the voltage applied at the terminals of the electrode is between 100 V and 3000 V.

According to one embodiment, the gas includes nitrogen, argon or oxygen, the gas being subjected to a pressure of between 400 hPa and 2000 hPa.

According to one embodiment, the charge density within the ionic amorphous material, the voltage applied at the terminals of the first electrode and the charged plasma are configured to generate, for a predefined duration, displacements of the negative charges along directions parallel to the plane of the surface of the amorphous material, said displacements occurring in a surface thickness of less than 3 micrometers.

According to one embodiment, the anode includes a geometry configured to define polarized regions (Zpi) at the surface of the ionic amorphous material (MA), each region being comprised between the portions of the first electrode.

According to one embodiment, the anode includes a geometry configured to define regions within which the surface currents generated at the surface of the ionic amorphous material induce the creation of a plurality of polarized areas delimited at least in part by the limits of each region, said polarized areas being created at the surface of the amorphous material.

According to one example, the regions circumscribed by the electrode portions including dimensions along each of the two axes in the plane of the surface greater than 5 micrometers.

According to one embodiment, the anode includes a geometry forming cells closed by linear portions of said anode in which surface currents (S(Ch−)) are generated to induce circumscribed polarized areas at the surface of the ionic amorphous material, said circumscribed polarized areas including dimensions along each of the two axes in the plane of the surface of the ionic amorphous material greater than 2 micrometers and being defined by a polarization direction induced by the direction of the surface currents (S(Ch−)).

According to another aspect, the invention relates to a treated ionic amorphous material including at least one electrically polarized area, said electrically polarized area being intended to receive liquid crystals.

According to one embodiment, the surface of a treated ionic amorphous material of the invention is made by means of a method of the invention.

According to another aspect, the invention relates to a liquid crystal cell (S_{CL}) characterized in that it includes:
a first surface of an ionic amorphous material treated according to the method of the invention;
a second surface of a material arranged so as to maintain liquid crystals in a sandwich structure,
a liquid crystals oriented along the polarization direction(s) of each polarized area of said first surface.

According to one embodiment, the material having the second surface in contact with the liquid crystals comprises a multilayer structure having a first layer of polyimide material and a second layer of an amorphous material maintaining the first layer.

One advantage of the use of a polyimide layer is to homogenize the effect induced by the electrical charges of the second surface or to limit heterogeneous effects on the alignments of the liquid crystals controlled by the first surface.

According to one embodiment, the second surface is a surface of an amorphous material treated according to the method of the invention, said second surface being engaged with the first treated surface by means of fastening elements, the two surfaces being maintained together with a constant inter-surface thickness and adapted to the dimensions of the liquid crystals.

According to one embodiment, the distance between the two planes between the first and second surface is between 5 and 10 micrometers.

According to one embodiment, the thickness of the area located between the two surfaces into which the liquid crystals are inserted is between 5 and 100 micrometers.

According to one embodiment, the ionic amorphous material is an ionic glass, such as a calcium sodium silicate ionic glass, or a glass including alkali or alkaline earth elements.

### BRIEF DESCRIPTION OF THE FIGURES

Other characteristics and advantages of the invention will become clearer on reading the following detailed description, in reference to the appended figures, that illustrate:

FIG. 1: an exemplary embodiment of the main steps of the method for treating an ionic amorphous material for its use with liquid crystals;

FIG. 2: an example of a multilayer structure making it possible to create a treated ionized glass layer and its use in a liquid crystal cell so as to control the alignment of the liquid crystals;

FIG. 3: an example of formation of a surface plasma generated to polarize an ionic glass used so as to be used with liquid crystal cells,

FIG. 4: an example of an amorphous material such as a glass treated by the method of the invention including different areas having different polarizations.

### DESCRIPTION OF THE INVENTION

### Method

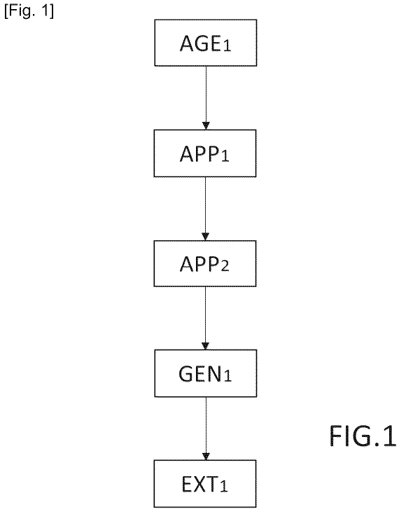

FIG. 1 describes the main steps of the method for treating a surface of an ionic amorphous material MA. The polarized amorphous material obtained by the method of the invention is advantageously used to structure liquid crystal cells. Given the correspondence between the electrical properties of the desired polarized amorphous material and the use of a configuration obtained to induce alignments of liquid crystals, the method described hereafter may refer to technical effects sought when said material will be used in a second step to structure a liquid crystal cell.

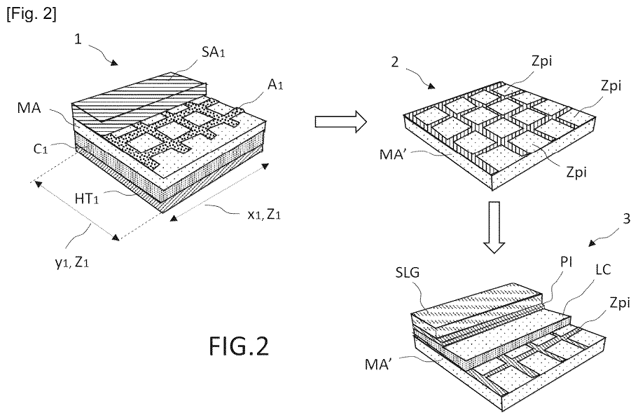

A first step of the method of the invention comprises an arrangement AGE of the surface of ionic amorphous material MA in contact with or near at least one first electrode A₁, C₁, structured geometrically. A heat source is arranged to control the temperature of the amorphous material MA. The different layers thereby arranged form a multilayer structure 1 represented in FIG. 2. Such an arrangement of layers allows the implementation of the method of the invention.

A “surface of a material” designates the geometric surface of the material and also the surface as a part of the material. It is therefore considered in the remainder of the description that a treatment of the surface of a material induces a treatment in a given thickness of the material. The thickness considered remaining negligible with regard to the transversal dimensions of the surface, the surface of the material designates its transversal dimensions considered with the dimension corresponding to a thickness over a fraction of the total thickness of the material.

### Electrode

FIG. 2 describes one embodiment of an arrangement AGE; of an electrode A₁, C₁ with respect to a surface of an ionic amorphous material MA, such as glass, for its treatment by the method of the invention.

Thus, the arrangement AGE₁ represented by the multilayer structure 1 of FIG. 2 illustrates the first step of the method of the invention in which a surface of an ionic amorphous material MA is arranged for its treatment in contact with an electrode A₁, C₁. Electrode A₁, C₁ comprises an anode A₁ and a cathode C₁. According to one example, the cathode C₁ is arranged on one face of the ionic amorphous material MA and the anode A₁ on the other face of the same ionic amorphous material MA. The electrode A₁, C₁ is supplied by a voltage source applied within the electrode A₁, C₁ is controlled by the application of an electrical voltage at the terminals of the electrode 1, A₁, C₁.

Preferentially, the anode A₁ and the cathode C₁ or the anode A₁ or the cathode C₁ are parts of a planar electrode. The geometry of the anode A₁ is, for example, structured in the plane so as to induce desired electrical properties in the ionic amorphous material MA. It is therefore preferably structured in a plane parallel to the plane of the surface of the amorphous ionized material MA. According to the example in FIG. 1, the anode A₁ is arranged on a surface portion Z₁ represents a section of the ionic amorphous material MA to be treated. In the example of FIG. 1, the anode A₁ is maintained between the surface of the ionized amorphous material MA and a layer of a substrate SA₁ having no electrical property, or at least negligible with respect to the electrical properties of the ionic amorphous material MA. The layer of the substrate SA₁ is for example a non-ionic glass forming an electrical insulator.

According to one embodiment, an electrode A₁, C₁ having a 2D geometry makes it easier to control the surface currents in 2D. Consequently, a 2D control of the currents makes it possible to induce the formation of multi-domain liquid crystal alignments when the latter will be near the surface of the treated amorphous material.

This type of electrode A₁, C₁ may be formed of micro-volumes delimited from each other by barriers formed of conductive materials having determined electrical potentials. For example, within one of these micro-volumes, the surface currents are multidirectional according to the geometry of the volume and the voltage applied and any electrically charged gas that may occupy this volume. It is therefore understood that the method of the invention makes it possible to configure and induce multi-domain polarizations according to the configuration of the micro-volumes and their distribution with respect to one another.

The method of the invention therefore allows the formation of several alignment domains within the same micro-volume as long as it is possible to associate spatialized surface currents with regions to be polarized of an ionic amorphous material to induce in a second step alignments of objects sensitive to this polarization arranged near the polarized amorphous material. The geometry of the surface currents, i.e. the orientation of the surface currents, may be deduced by the use of simple electrostatic models and modeling them with respect to a given electrode geometry and the composition of the glass and other variable parameters for implementing the method of the invention, namely the temperature of the material, the voltage applied, etc.

Indeed, to control the shape of the surface currents generated at the surface of the amorphous ionic material MA and therefore the polarizations likely to be generated within the material and therefore the alignment domains of the liquid crystals that can be induced, it is possible to apply different electrical potentials in several regions of the electrode A₁, C₁. An alternative would be for example the use of several positive electrodes arranged according to a predefined configuration.

According to different embodiments, the voltage may be applied with a constant or variable value. An applied voltage having a continuous value makes it possible for example to obtain a first dynamic of migration of the charges within the amorphous material and the plasma. This dynamic may for example be adjusted as a function of the duration of application of the voltage to obtain a given surface current. An applied voltage having a variable value may be of interest in other use cases involving a particular bringing under control of the migration dynamic of charges within the amorphous material or plasma. In the latter case, the value of the voltage may be determined and/or commanded for example by a function implemented in an electronic board driving the voltage source at the terminals of an electrode. The function may make it possible to generate pulses with a given frequency or according to another example the function may make it possible to generate an alternating voltage in the form of a square-wave signal or a sinusoid. More generally, when a variable voltage is applied, the frequency, the amplitude and the phase of the voltage may be controlled according to a given function implemented by means of calculating and driving the voltage.

According to one embodiment, different voltage values are applied at the terminals of a plurality of electrodes in order to induce surface currents at the surface of the amorphous material. This possibility makes it possible to obtain polarized areas with different electrical properties depending on the areas considered.

According to one embodiment, the method of the invention can take into account the spatial variation of the applied electrical potential to allow the bringing under control of the shapes or geometries of the surface currents generated at the surface of the amorphous ionic material MA. These shapes and/or these geometries correspond to orientations of surface currents forming parallel to the surface of the material. These shapes or geometries make it possible to induce polarizations likely to be generated within the material. These polarized areas thereby induced allow, when using a treated material, to define different alignment domains of the liquid crystals CL.

According to one embodiment, the electrode A₁, C₁ is of the point or wire type. One interest is to design electrode geometries defining regions within which a control of spatialized surface currents is configurable.

### Geometry of the Anode

According to one embodiment, the anode A₁ forms a grid as represented in FIG. 2, the grid is a grid pattern of which each branch has a given thickness and a predefined distance between two thicknesses. According to the example in FIG. 1, the thickness of the branches of the grid of the anode A₁ is 10 micrometers and the distance between two branches is 40 micrometers.

According to other examples, the width of the anode portions A₁ in the plane parallel to the plane of the surface of the amorphous material MA is between 1 micrometer and 20 micrometers.

According to one embodiment, the distance between the portions of anode A₁ in the plane parallel to the plane of the surface of the amorphous material MA is between 15 micrometers and 400 micrometers. One interest of the invention is to allow the control of surface electrical current generated by the formation of a plasma over distances of up to several hundred micrometers. One interesting range is notably between 5 micrometers and 200 micrometers. These distances are particularly difficult to control from electrodes as this implies the use of electrode geometries difficult to implement with reduced control of the addressed regions of the ionic amorphous material MA.

According to other embodiments, the structure of the anode A₁ may take different shapes, it may involve more or less complex geometric shapes. For example, the anode A₁ may comprise a structure having a geometric ring shape, a hollow shape, a shape having a plurality of parallel straight branches and more generally any other geometric shape inscribed in a plane. The geometric shape of the anode A₁ may comprise a duplicated repetitive pattern with the same dimensional properties, such as squares of the same size spaced at a certain distance or with different dimensions such as squares nesting inside a larger square and offering space for a smaller square.

Thus, the electrode A₁, C₁, and more specifically the anode A₁ in the case of the example makes it possible to define regions within which the surface currents are brought under control to form electrical polarizations within the ionic amorphous material MA.

Thus, the anode A₁ may include a geometric shape having at least one symmetry, such as a symmetry with respect to an axis or a rotational symmetry. According to another example, the anode A₁ includes a geometric shape such that a part of the anode A₁ is obtained by a geometric transformation of another part of the anode A₁. According to one example, this transformation is a homothety. Thus, it is possible to generate concentric or nested shapes.

One advantage of shapes having repetitive patterns is that they make it possible to obtain a polarized glass for applications with cell structures such as liquid crystal cells. These applications are particularly interesting notably for liquid crystal displays or the design of optical components.

The multilayer structure 1 of FIG. 2 makes it possible to carry out a method for treating an ionic glass MA, the glass being an amorphous material of particular interest for applications specific to defining liquid crystal cells. According to one example, a glass of the sodium calcium silicate glass type may be used.

The multilayer structure 1 of FIG. 2 also comprises the arrangement AGE₁ of a cathode C₁ on the other surface of the ionic amorphous material MA. This arrangement AGE₁ of sandwich layers makes it possible, when the electrode A₁, C₁ is energized, to migrate the electrons or anions in the amorphous ionic material MA.

### Application of a Temperature

In order to facilitate or make possible the migration of electrons or anions in the ionic amorphous material MA, a layer HT₁ is used to heat the surface of the ionic amorphous material MA. This source comprises for example a heating plate in order to heat the surface of ionic amorphous material MA over a complete region defining the surface of the plate. The heating of the surface of the ionic amorphous material MA makes it possible to facilitate the displacement of electrons or anions within the surface of the amorphous material MA. The arrangement of the heat source HT1 may be done in various ways. According to one embodiment, a heating plate may be used. According to another embodiment, a temperature may be provided by radiation by a radiant source. According to another embodiment, the multilayer structure 1 is disposed within an adiabatic enclosure that allows temperature control of the ionic amorphous material MA.

A second step of the method therefore comprises the application of a given temperature to the ionic amorphous material MA from a heat source HT₁ on a first region Z₁ of said ionic amorphous material MA. The area may correspond to the entire surface of the ionic amorphous material MA.

Depending on the material chosen, the temperature may vary in order to promote the displacement of electrons or anions within the ionic amorphous material MA. The temperature may vary according to a preferred temperature range and must remain below the glass transition temperature of the ionic amorphous material MA.

### Application of a Voltage

A third step comprises the application APP₁ of a voltage at the terminals of the first electrode A₁, C₁ in order to generate an electric current intensity within the anode A₁ and the cathode C₁. This step is preferably carried out simultaneously with the step of heating the material. This voltage may be controlled so as to promote the displacement of charges within the ionic amorphous material MA. The period of application of the voltage is also parameterized according to the given case during a given period Td. The period may be configured according to the desired surface currents generated in order to obtain a desired polarization of the material MA.

One of the aims sought of the arrangement AGE₁ of this multilayer structure 1 and the thermoelectric configuration of the first steps of the method is the generation GEN₁ of a surface plasma PL₁ at the surface of the ionic amorphous material MA between at least two portions of the anode A₁ defining a micro-volume confined between these anode portions A₁.

Under the effect of the electric field and temperature, an alkali and/or alkaline earth depletion forms within the vitreous matrix over a thickness of several micrometers at the anode surface of the treated glass. This phenomenon is also known as “poling” on a glass in Anglo-Saxon terminology. The amount of cations displaced by this charge separation mechanism defines the surface density of negative charge induced during the treatment. This charge surface density may be controlled by different parameters, of which notably:
the composition of the glass and notably its concentration in alkali elements,
the treatment temperature,
the applied voltage values, and
the dimensions of the electrode.

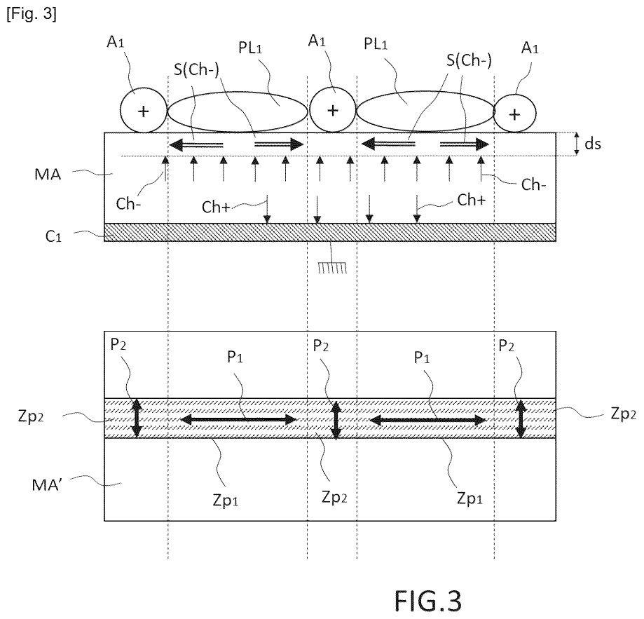

According to one example, the electrode is a wire electrode of the tungsten wire type with a diameter of 80 μm. This electrode is placed in contact with a surface of calcium sodium silicate glass. The treatment is carried out at 240° C. for a voltage of 1400V. The example of the ionic amorphous material MA in FIG. 3 may be treated with the same configurations, namely a temperature of 240° C. and a voltage of 1400V at the terminals of the electrode A₁, C₁.

### Generation of a Surface Plasma

When the charge surface density is sufficient on a given domain, the ionization of the gas in contact with the charged surface allows the formation of plasmas and surface currents causing an electrical polarization effect in the plane of the surface of the vitreous matrix.

The method of the invention makes it possible to define a configuration ensuring a sufficient generated charge surface density is obtained during the treatment to produce a static electrical field of a sufficient amplitude. Sufficient amplitude is defined according to the use case, such as the amplitude necessary to generate an orientation or an alignment of liquid crystals. Conversely, the method makes it possible to limit the charge surface density obtained in order to avoid damaging the ionic glass substrate.

It is understood how useful it is to create electrode geometries defining micro-volumes within which it is possible to generate brought under control surface currents induced by the formation of surface plasma.

Obtaining a plasma is promoted by the presence of an initially neutral gas confined between said at least two portions of the anode A₁ when the voltage is applied and the heat is brought to the ionic amorphous material MA. The application of the voltage and the heat makes it possible to promote the ionization of the gas then forming a surface plasma.

The invention derives an advantage from a chosen structuring of the electrode, notably the anode A₁ so as to define confined regions of significant dimensions relative to the electrode portions. The gas allows the formation of a plasma within which the displacement of charges from the ionic amorphous material MA is possible. This displacement allows the formation of a surface current.

The method of the invention allows the formation of surface plasmas that allow the control over adjustable distances of surface currents at the surface of the ionic amorphous material towards the positive electrode.

The regions of formation of these surface currents/plasmas define the areas that are electrically activated due to an electrical polarization of the material according to the direction of the currents formed. Thus, in a same region defined by the geometry of the electrode, several areas having different electrical polarizations may be generated.

Indeed, a region defined by the structuring of the electrode makes it possible to induce different polarization areas according to the displacements of the surface currents at the surface of the amorphous material delimited by said region. Typically, an electrode defining a region of parallelogram shape makes it possible to define 4 areas of polarization of triangular shape, the surface currents being oriented from the center of the region to each branch of the parallelogram. If the electrode has a circular shape, the polarization area is defined according to a radial polarization geometry obtained thanks to surface currents oriented from the center of the circle to the circumference of the circle.

The material thereby modified allows for example a control of the alignment of liquid crystals as detailed below.

According to the example of the grid of FIG. 2, the polarization effect of the glass surface occurs on the contact areas between the grid and the glass and by the formation of surface plasmas in the micro-volumes of gasses present at each interstice of the grid. There are therefore two regions that are subjected to different electrical stresses depending on the contact of the ionic amorphous material with the electrode or with the plasma.

To bring under control the dimension of the treated surfaces, in addition to the parameters of composition of the glass, the temperature, the applied voltage and the geometry of the electrode to control the charge surface density, a fifth parameter may be defined. The fifth parameter may be defined by the properties of the gas used, notably its composition, its pressure and the dimension of the volume of gas in contact with the electrode and the glass surface to be treated.

During the treatment of the surface of the ionic amorphous material, the temperature and the voltage may be stopped so as to freeze the polarization in the treated amorphous material MA′.

For a single domain, a surface plasma may be brought under control at micrometric scales ranging from 5 to 500 μm.

The use of spatially controlled plasmas/surface currents at micrometer scales allows an electrical polarization of the surface of an ionic glass to be induced. The treated glass surface may then be used for applications aimed at controlling an object sensitive to static electromagnetic fields obtained by this polarization. One interest of the invention is to use this type of treated glass with liquid crystals in such a way as to force their alignment. Thus, the invention allows the formation of multi-domains of alignments of these liquid crystals.

The configuration of the multilayer structure 1 of FIG. 2 allows a preparation of the ionic glass surface MA by the use of surface plasmas induced by the thermoelectric treatment according to the operation described in FIG. 3. One of the advantages of the invention is to use the geometry of the electrode A₁, C₁ used to spatially bring under control the senses of the surface currents of the amorphous ionic material MA. The geometry of the electrode A₁, C₁ may thus be adapted according to the desired application.

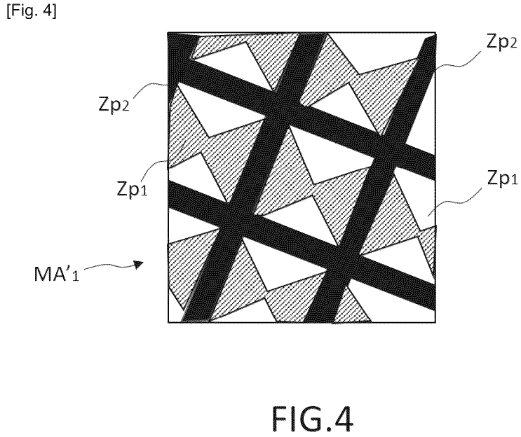

FIG. 3 represents an ionic amorphous material MA comprising alkali or alkaline earth type mobile cations. When it is heated and the electrode A₁, C₁ is energized, the voltage at the terminals of the anode promotes the migration of electrons or anions of the amorphous ionic material MA to the surface as the arrows Ch-represent it. Conversely, the positive charges, the cations Ch+ migrate to the cathode C₁. The region located at the surface of the ionic amorphous material MA between two portions of anode A₁ comprises a gas which under the effect of the electromagnetic field generated locally by the electrode promotes the creation of a charged surface plasma PL₁. The plasma includes electrical charges created during the application of the electrical field induced by energizing the electrode A₁, C₁. Thus, the plasma PL₁ allows a displacement of charges within the plasma at the surface of the amorphous material in a plane parallel to the plane of the surface of the ionic amorphous material MA. The plasma PL₁ has the effect of generating a surface current noted S(Ch−) between the surface of the ionic amorphous material (MA) and the portions of the electrodes A₁. FIG. 3 represents between each electrode A1 surface currents S(Ch−) having opposite directions under a same region including the plasma, the arrows representing the directions of the surface currents obtained thanks to the configuration of the electrodes. These opposite directions notably explain the geometric triangle shapes obtained in FIG. 4 when a grid-shaped electrode is used.

The generation of this plasma PL₁ is notably made possible by putting in place an area having a sufficient dimension between the portions of anode A₁. According to one example, at least two portions of the anode A₁ are separated by a distance of between 5 micrometers and 500 micrometers. In a preferred embodiment, the portions of anode A₁ are organized to form closed containment areas having the shape of a circle, square, rectangle, triangle or any other shape used according to the desired application case.

FIG. 3 also represents a surface of polarized amorphous material MA′ obtained by means of the method of the invention. This surface is represented in a top view with respect to the sectional view of the amorphous material MA represented above. This treated surface comprises alternations of areas Zp₁ and Zp₂ which are determined as a function of the electrical polarization of said areas. The areas Zp₂ located under the anode A₁ are polarized along a first direction in the plane of the polarized amorphous material MA′ and the areas Zp₁ located under the plasma A₁ are polarized along a second direction perpendicular to the first direction and also contained in the plane of the polarized amorphous material MA′. Other types of polarizations may be obtained according to the anode A; used and more generally the geometry of the electrode A₁, C₁ and the dimensions of the confined spaces between the portions of anode A₁. Notably, it is possible to generate polarizations along different directions within a micro-volume by bringing under control the sense and/or directions of the currents in the micro-volume.

The plasma PL₁ thereby formed at the surface of the ionic amorphous material MA makes it possible to modify the electrical properties thereof to define at least one locally electrically polarized ionic area Z₁.

Thus, the geometry of the micro-volumes formed between the different portions of anode A; allows the control of the direction and/or the sense of the electrical currents along the surface of the glass substrate, the effects of which will subsequently allow control of the orientation of the liquid crystals when the substrate will be used in the design of a liquid crystal cell LC.

Thus, this type of substrate may then be used for the manufacture of a liquid crystal cell by eliminating the use of a polymer film during the manufacture of a liquid crystal cell.

Another advantage is the open possibility of manufacturing multi-domains of planar alignment, of which the orientation axis and the dimension are controlled by the parameters of the treatment of the glass substrate.

FIG. 4 illustrates an effect of the multi-domain polarization of a treated amorphous material obtained between the anode portions A₁ of a grid type electrode such as that of FIG. 3. The polarizations are differentiated according to the triangular shaped regions in the micro-volumes between the grid shaped traces that were in contact with the electrode A₁.

Observation under optical microscopy of the amorphous material between two cross-polarizers shows that the areas that have been in contact with the grid induce an orientation of the liquid crystals perpendicular to the surface of said amorphous material. In the area corresponding to the interstice of the grid, 4 domains of distinct planar orientations and triangular shape Zp1 were formed. In each of these four triangular shaped domains Zp1, the orientation of the liquid crystals CL is planar and perpendicular to the edge of the nearest grid. The directions of each of the 4 areas Zp1 contained within a same rectangular or square region delimited by the wire portions of the electrode comprise different directions.

The method of the invention makes it possible to control the duration of application of the surface treatment in order to obtain a desired polarization of the ionic amorphous material MA. When the treatment is completed, an extraction step EXT₁ of the ionic amorphous material MA is performed. The extraction EXT₁ consists in the separation of the ionic amorphous material MA from the other layers of the multilayer structure 1 of FIG. 1.

FIG. 2 represents a surface of ionic amorphous material 2 also noted MA′ thus obtained by the method of the invention. The ionic amorphous material MA′ comprises two types of areas: Zp₁ and Zp₂.

First areas Zp₁ correspond to the areas of the ionic amorphous material located between the anode portions A₁. In these regions, a first electrical polarization of the surface of the ionic amorphous material MA is induced by the method of the invention.

Second areas Zp₂ correspond to the areas of the ionic amorphous material that were located under the portions of anode A₁ or that were in contact with the portions of anode A₁. In these regions, a second electrical polarization of the surface of the ionic amorphous material MA′ is induced by the method of the invention.

### Use to Define Liquid Crystal Cells

The surface of treated amorphous material MA′ comprises a structuring of induced polarized areas corresponding to the geometry of the electrode A₁, C₁. One advantage of the controlled polarization of certain areas is the creation of a static electromagnetic field within the polarized amorphous material MA′. This field makes it possible to control the alignment of liquid crystals that would be placed in contact with the surface of the polarized amorphous material MA′.

One example of liquid crystals of which the orientation may be governed by a surface treated by the method of the invention is the family of nematic liquid crystals such as hexyl-biphenylcabonitrile.

Indeed, a consequence of the method of the invention is the development of a direct link between the sense of the currents during the thermoelectric polarization method and the direction of alignment of the liquid crystals CL obtained at the treated surface. The senses of the electrical currents at the surface of the amorphous material are brought under control by the configuration of the electrodes used during the method of the invention.

To obtain a homeotropic orientation perpendicular to the surface of the liquid crystals CL, a uniform electrode close to or in contact with the surface may be used.

For a planar orientation of the liquid crystals CL, the method of the invention may implement a configuration allowing the generation of currents having a majority component along the surface and perpendicular to the positive electrode in the surface plasma formation area. In these areas, the induced currents along the glass surface allow a planar alignment of the liquid crystals CL along the direction directly perpendicular to the positive electrode and parallel to the glass surface.

The invention also relates to the use of such a polarized amorphous material to define liquid crystal cells.

An ionic glass layer thereby treated allows the manufacture of a liquid crystal cell having spatially controlled planar and non-planar orientation domains. The geometry of the surface currents of the treated glass controlled by means of the method of the invention allows a spatial bringing under control of the alignment directions of the liquid crystals LC in interaction with the treated surface of the polarized glass used.

Such a liquid crystal cell 3 is obtained and represented in FIG. 2. The cell 3 is delimited by the surface of the polarized amorphous material MA′ according to the method of the invention.

The multilayer structure 3 of FIG. 2 comprises in this example case liquid crystals LC, said liquid crystals LC being maintained between two surfaces by means of an adapted geometry of said layers disposed on either side of the liquid crystals. A first layer of a polarized amorphous material MA′ and a second layer of polyimide material PI. An additional layer SLG of an amorphous material noted MA₂ may be used to maintain the polyimide layer PI.

The multilayer structure 3 of FIG. 2 is also referred to as the liquid crystal cell SCL.

One interest of the invention is to define liquid crystal cells of which the orientation is governed not by the surface condition of a polymer, but by a static electrical field. Depending on the orientation of this static electrical field, the orientation of the liquid crystals may be governed so as to promote a perpendicular alignment or an alignment parallel to the plane of the surface of polarized amorphous material MA:

According to one embodiment, the surface of the polarized amorphous material MA′ is associated with elements making it possible to engage said surface with a second surface arranged in parallel. The region between the two surfaces defines a receiving area for receiving liquid crystals LC. These can be introduced by capillarity and kept confined within the sandwich structure.

In the case where the two surfaces define a liquid crystal cell, the filling of the cell may be carried out in a vacuum oven. Once the vacuum is established, the cell is heated in order to make the liquid crystal pass into an isotropic phase and obtain the filling of the cell. This technique is notably effective on small cell sizes. For larger cell sizes, a pressurization technique known to those skilled in the art for the filling may also be implemented.

According to one embodiment, the liquid crystal cell SCL includes a second surface of an amorphous material arranged so as to maintain the liquid crystals within a sandwich structure with the first surface of the polarized amorphous material MA′. According to one example, the second layer comprises a first sub-layer of polyimide material PI and a second sub-layer SLG of an amorphous material MA₂. In the latter case, the role of this second sub-layer is in particular to maintain the polyimide layer.

According to one embodiment, the second surface includes a surface geometry adapted to form with the first surface a sandwich structure including an inter-surface space. The inter-surface space is designed to define a spacing adapted to receive liquid crystals in order to define a liquid crystal cell LC.

The first surface MA′ and the second surface SLG, PI may be maintained thanks to a means of fastening so as to engage the two surfaces together and maintain a predefined distance between the two surfaces. One example of a means of fastening is the use of micrometric glass beads mixed with a UV adhesive. The mixture is thus applied, for example, to the four corners of the two surfaces to be assembled. The mixtures are then cross-linked by the application of a UV light. According to this example, the liquid crystals are introduced by capillarity between the two surfaces to be assembled and are heated so that they are in their isotropic phase. On cooling, they then pass into the nematic phase and then naturally orient themselves according to the polarization of the material of the first surface.

One advantage of the invention is to modify the electrical properties of a material, for example a vitreous material such as glass, with the objective of controlling the optical properties of a liquid crystal cell. One interest is to custom functionalize a glass for given applications.

The invention derives an advantage from the fact that the liquid crystals are sensitive to electrical fields. One advantage is to dispense with the use of more complex solutions for controlling the alignments from so-called “photo-alignment” techniques. For example, the invention makes it possible to avoid the use of a photosensitive dopant within the liquid crystals or the use of a polymer having been treated by surface chemistry with a photosensitive molecule that will be oriented according to the polarization of the light.

The method simplifies the production of liquid crystal cells and requires fewer components.

The liquid crystal cell of the invention may be associated with a system generating an electrical field controlling the orientation of the main axis of the liquid crystals. According to one example, transparent electrodes may also be implemented to control the electrical field in order to orient the crystals to manage an alignment dynamic of said crystals as for the pixels of a display. Electrodes may be used to manage an alignment dynamic such as an alignment frequency.

Polarizers may be configured on either side of the liquid crystal cell in order to control the polarization of the light passing through the liquid crystal cell. Thus, the control of the electrical field and polarizers allows different uses of the liquid crystal cell which is illuminated by a light source.

According to one embodiment, the liquid crystal cell is associated with crossed optical polarizers.

The polarized amorphous material may be a glass also serving as support and outer surface of the liquid crystal cell.

Another advantage of the invention is to propose a solution able to be implemented in vertical alignment technologies that are increasingly used.

1. A method for treating a first surface of an ionic amorphous material comprising:
arranging said first surface of the ionic amorphous material in contact with or near at least one first electrode structured geometrically;
applying a temperature to said ionic amorphous material from a heat source on a first area of said ionic amorphous material;
applying a voltage at terminals of the first electrode of a predefined value for a given period;
generating a plasma at the first surface of the ionic amorphous material from the ionization of a gas located between said first surface of ionic amorphous material and different portions of the first electrode and the application of a given voltage at the terminals of the first electrode, said application of the voltage at the terminals of the first electrode and said generation of plasma being configured so as to modify surface electrical properties of said ionic amorphous material to define at least one area of the surface locally polarized between the different portions of the first electrode;
extracting the treated ionic amorphous material, polarized ionic amorphous material being used to define a liquid crystal cell.

2. The method for treating a surface of an ionic amorphous material according to claim 1, wherein said different portions of the first electrode are separated by a distance of less than 500 micrometers.

3. The method for treating a surface of an ionic amorphous material according to claim 1, wherein the plasma is a cold plasma or a dielectric barrier discharge type plasma.

4. The method for treating a surface of an ionic amorphous material according to claim 1, wherein the first electrode comprises an anode arranged in contact with or near the first surface of the ionic amorphous material to be treated and a cathode arranged on or near a second surface of the ionic amorphous material, said gas confined between the first surface of the ionic amorphous material and the different portions of electrodes undergoing an ionization forming plasma discharges.

5. The method for treating a surface of an ionic amorphous material according to claim 1, wherein applying the voltage at the first electrode induces a displacement of the mobile cations under the first surface of the ionic amorphous material towards a cathode and a displacement of negative charge carriers including electrons and/or anions towards the first surface of said ionic amorphous material, said displacement of negative charges carriers at the surface of the ionic amorphous material generating the plasma at the first surface of the ionic amorphous material and forming a surface current, a propagation orientation of which is controlled in a plane of the surface of said ionic amorphous material by a geometry of an anode of the first electrode.

6. The method for treating a surface of an ionic amorphous material according to claim 1, wherein a charge density within the ionic amorphous material and the voltage applied at the terminals of the first electrode are configured to generate for a predefined duration displacements of the negative charges carriers along directions parallel to the plane of the surface of the amorphous material, said displacements occurring in a thickness of the surface less than 3 micrometers.

7. The method for treating a surface of an ionic amorphous material according to claim 5, wherein the anode includes a geometry configured to define regions within which the surface currents generated at the surface of the ionic amorphous material induce the creation of a plurality of polarized areas delimited at least in part by the limits of each region defined by the geometry of the anode, said polarized areas being created at the surface of the amorphous material.

8. The method for treating a surface of an ionic amorphous material according to claim 5, wherein the anode includes a geometry forming cells closed by linear portions of said anode in which surface currents are generated to induce circumscribed polarized areas at the surface of the ionic amorphous material, said circumscribed polarized areas including dimensions along each of the two axes in the plane of the surface of the ionic amorphous material greater than 2 micrometers and being defined by a polarization direction induced by the direction of the surface currents.

9. A treated ionic amorphous material comprising at least one electrically polarized area, said electrically polarized area being intended to receive liquid crystals.

10. The treated ionic amorphous material, wherein said material is made by means of a method of claim 1.

11. A liquid crystal cell comprising:
a first surface of a treated ionic amorphous material according to claim 9;
a second surface of a material arranged so as to maintain liquid crystals in a sandwich structure,
liquid crystals oriented along polarization direction(s) of each polarized area (Zi) of said first surface.

12. The liquid crystal cell according to claim 11, wherein the material having the second surface in contact with the liquid crystals comprises a multilayer structure having a first layer of polyimide material and a second layer of an amorphous material maintaining the first layer.

13. The liquid crystal cell according to claim 12, wherein the second surface is a surface of an amorphous material according to claim 9, said second surface being engaged with the first treated surface by fastening elements, the first treated and second surfaces being maintained together with a constant inter-surface thickness and adapted to the dimensions of the liquid crystals.

14. The liquid crystal cell according to claim 11, wherein the ionic amorphous material is an ionic glass, or a glass including alkali or alkaline earth elements.

15. The liquid crystal cell according to claim 14, wherein the ionic glass is a calcium sodium silicate ionic glass.
